(19) United States
(12) Patent Application Publication
(10) Pub. No.: US 2008/0294972 A1
(43) Pub. Date: Nov. 27, 2008

(54) SYSTEM AND METHOD FOR ADDING A LAYER OF MARKS ON TOP OF WEB-PAGES

(75) Inventor: Henrik HJELTE, Bromma (SE)

Correspondence Address: DRINKER BIDDLE & REATH (DC), 1500 K STREET, N.W., SUITE 1100, WASHINGTON, DC, 20005-1209, US

(73) Assignee: Stix.to ab, Bromma (SE)

(21) Appl. No.: 12/123,691

(22) Filed: May 20, 2008

Related U.S. Application Data
(60) Provisional application No. 60/924,562, filed on May 21, 2007.

(51) Int. Cl. G06F 17/00

(52) U.S. Cl. 715/201

(57) ABSTRACT

A system and method to put graphical marks such as post-it style notes, stickers and bookmarks on top of web pages is disclosed.

### RELATED APPLICATION DATA

This application claims priority under 35 U.S.C. §119(e) to U.S. Provisional Application No. 60/924,562, filed May 21, 2007, entitled “System and Method for Adding a Layer of Marks on top of Web-Pages”, the entire contents of which are incorporated herein by reference

### FIELD

The present disclosure relates to a way to put graphical marks such as post-it style notes, stickers and bookmarks on top of web pages.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

U.S. Pat. No. 6,687,878 B1 discloses a system for collaborating document annotating internal documents stored on a document file server. The figures show that the document file server has a direct connection to the notes server. With the invention disclosed herein, there is no central documents server and no special document files, instead any document on the internet can be annotated.

Known in the prior art are systems for annotating documents stored on a number of central file servers. However, the invention disclosed herein allows adding marks to any document over the world wide web.

Also known in the prior arts are systems for annotating web-based documents by overlaying an image over a document. The invention disclosed herein is an improvement because the marks consists of html, script and markup language elements that blend with the html, script and markup language of the currently viewed document. This means that the marks are integrated with the browser window and the elements in the viewed document. For example, a graphical element such as a post-it note can have a relative position to an html element rather than an absolute x and y position. This can make the element appear at the correct place even when the original document is changed.

An additional advantage over prior arts is that several types of marks can be used in the same system. Notes, bookmarks and other graphical marks as well as non-graphical effects can be used in the same system.

Because the marks consists of code written in a scripting language such as javascript, which blends with the viewed document, the mark need not be a graphical element. It can also alter the viewed document in a way that the user wants. For example, a background sound can be played for amusement purposes or the colors of the viewed page may be changed.

Also known in the prior art is the greasemonkey web browser extension. It allows altering a html document before it is presented to the user by executing a locally stored javascript program. The invention disclosed herein uses greasemonkey for the specific purpose of adding marks to the page. Whereas, usually a greasemonkey script is stored locally, the invention disclosed herein dynamically retrieves the program code from the marks-server. The user does not have to do anything to download updates, The appearance and functioning of the marks is controlled by the marks-server. This makes it possible for the user to adapt the appearance and functionality of the marks simply by making choices in a web-interface at the stix.to webpage. By using the full power of a server connected with a database, interactions between users can affect the marks, which would be difficult or impossible to implement by a normal client-side greasemonkey script.

### SUMMARY

Graphical marks such as post-it style notes, stickers and bookmarks, can be placed on top of web pages.

For example, a person (the user) downloads a plug-in for his web browser from the webpage stix.to. This makes it possible for the user to add graphical elements such as post-it notes or bookmarks on top of any webpage that the user visits. These elements, which herein are called marks, will be visible to the user the next time he returns to the same page. The marks can also be visible to other people, for example coworkers, friends or people with the same interests. The invention gives a personalized and democratic view of the internet, useful for numerous reasons such as for amusement, for communicating with people, and for remembering and organizing websites.

A note is one kind of mark. A user can add a note resembling a bit of paper or a post-it type note on top of a webpage. He or she can then write a bit of text or make a drawing in it.

A bookmark is another type of mark. A bookmark is a visible figure that reminds the user of pages he or she likes. The next time the user returns to a page, his bookmark will appear again. A list of bookmarked pages can be shown on the stix.to website, to make it easy to structure and remember pages you like.

Hotmarks: A graphical figure resembling something hot, like a fireplace. You can add this mark to a page you read when you think it is interesting news and worth to see for other people. If several users do the same each day, by collecting statistics on the marks-server, a list of “hot” and interesting pages can be shown to every users gain. If you navigate to your individual page on the marks-servers website, you see a list of web pages suggested for you to visit today. The formula for ranking pages may be weighted by relations between users, so interests of people similar to you scores higher for your individual list.

Sticker: The user can upload a graphical picture file by using the web pages on the marks-server. It is then saved as the users own collection of stickers. The user can then add graphical designs on top of any website, shown for himself and friends. It may be for fun, or give special meaning in a group of friends, like hotmarks for a specific purpose. Music-fans may add a sticker resembling a guitar to bands web pages, and if you are one of them you will see that this band is something special.

Spray can: This is an example of another way of adding graphics in the layer above a website. This may be used as a new means of creating art or express thoughts.

Avatar: This is a graphical picture resembling “you”. This avatar is shown to your friends when the visit the same page as you do.

Talking message, a “speaker”: A user can choose a message, which is spoken out to a group of friends when they enter a website. The user clicks on a mouth, is presented by a form, writes a sequence of words, and chooses to whom it should be played back, that is another user or group of users. The sequence of words is converted to a sound file consisting of the messages spoken out by a digitized voice. When the receiver later visits the chosen page, the message will be spoken for him or her in the computers speaker.

Sound effect: The user can upload a sound file by using the web pages on the marks-server. It is then saved as the users own collection of sound-effects. Similar to the talking-message mark, he can choose to play back the sound to a receiver of his choice.

An exemplary system operable to change a web page with at least one element comprises computer means connected to a distributed computer network, display means connected to said computer means and operable to display images, and speaker means connected to said computer means operable to reproduce sounds, which computer means is, wherein said computer means comprises a web browser operable to show web pages on said display means, wherein said web browser comprises modification means operable to integrate to said at least one element with a browser window and the elements in the viewed document.

An exemplary method for changing a web page with at least one element comprises the steps: visiting a web page by selecting a URL in a web browser, sending information identifying said user and the current URL to server means, reading information from database means connected to said server means in order to determine if any element is to be integrated for said user; and, if an element is to be integrated, integrating said at least on element with a browser window and elements in the viewed document

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 shows two marks, post-it type notes, on top of a well known webpage.

FIG. 2 shows the physical parts of the system.

FIG. 3 shows the components of the system.

FIG. 4 schematically shows some computer software products 102₁, . . . , 102ₙ according to the present invention.

FIG. 5 is a graphical representation of a method for changing a web page with at least one element.

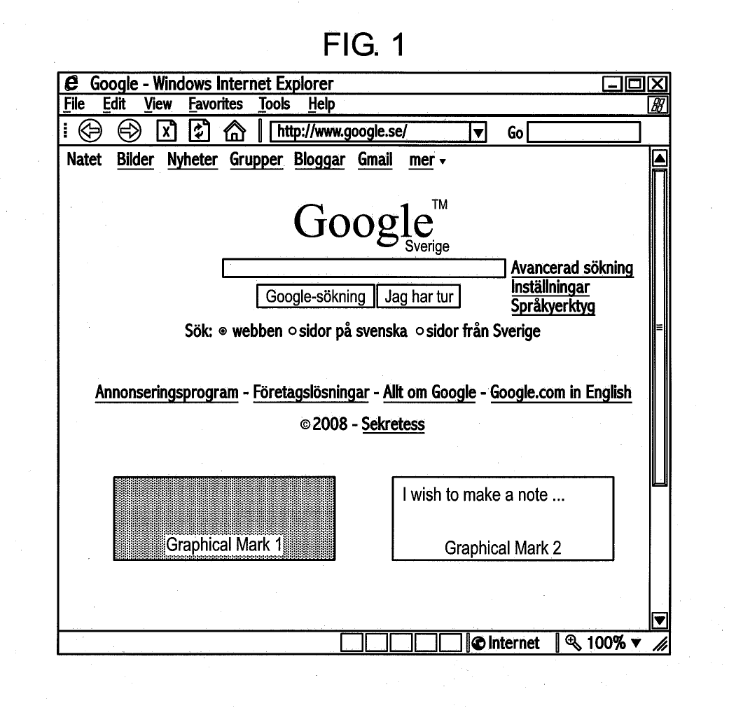

### DETAILED DESCRIPTION

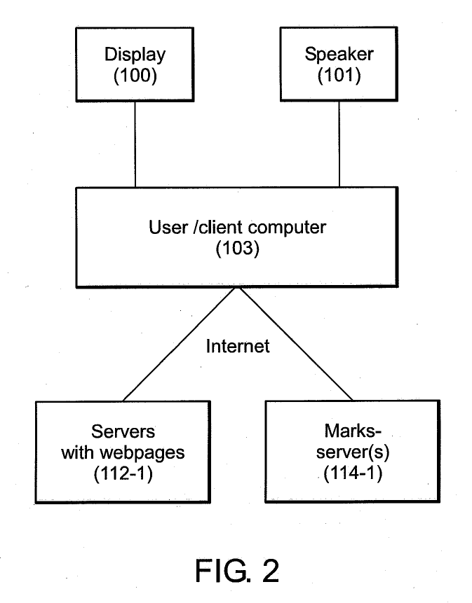

FIG. 2 shows the physical components of the system. The user has a computer (103) with an attached display (100) and speaker (101). The user computer 103 is connected to the internet and can download web pages from different servers 112-1. One such server is the marks-server 114-1, which provides facilities for this system.

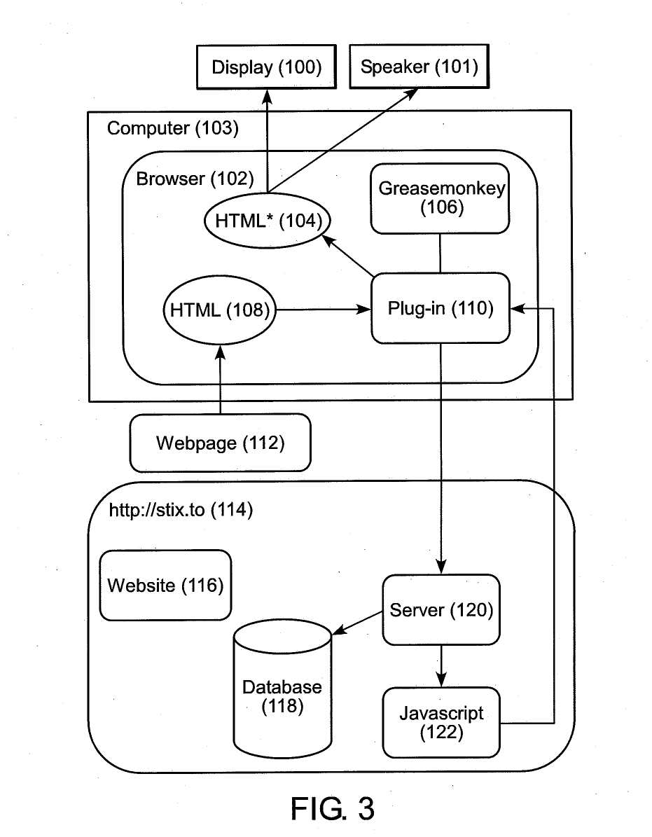

FIG. 3 shows the parts of the system. A person, the user, has a web browser (102) to show web pages on his or her display (100), and sounds on the speaker (101). The user visits a web page (112) by selecting a URL in the browser. The web browser downloads the HTML document (108) which describes how the webpage looks like. Without this invention, the HTML would be rendered by the web browser and shown to the user on the display (100). However, with this invention there are some intermediate steps. The plugin (110), which in the reference implementation is implemented using the greasemonkey plugin (106) and a javascript program, communicates with the server (120). After the web browser has downloaded the HTML document (108), the plugin sends information identifying the user and the current URL to the server (120). The server determines if any marks shall be shown for this user by executing a computer program that reads information from a database (118). If any marks shall be shown for this user, computer programs implementing the program codes for the marks are generated as javascript (122) and returned to the plugin. The plugin executes the returned javascript code, which alters the html of the webpage (108) and instead creates a modified version (104) that is shown to the user on a display (100). The modification to the original webpage (108) is typically to add program code and graphics to implement a mark, for example to show a note, bookmark or other visible item, but it can also be a non-graphical mark, like adding a sound that plays, some digitized spoken words, or altering the appearance of the page. Some javascript code is always added to the original web page. This is a program that is invoked when the user wants to add a new mark to the page. Then a choice of marks are presented to the user, determined by the server (120). Changing the internal state of the marks, for example moving a bookmark or writing text in a note, typically causes a request from the mark to the server (120), which saves the updated information in the database (118). That way the marks can be restored the next time the user returns to the web page.

The system also includes a regular website (116) that provides additional services and features to the users of the plug-in. This can be numerous things such as seeing which pages have marks, pages that are popular to add marks to, adapt the functionality of the marks, designing new marks, determining what marks the user wants to see. It can also be to connect, communicate and relate to other users and groups of users.

The website (116), the server (120) and the database (118) are computer programs installed on a number of server-computers (114), also called the marks-server. The plugin (110) is downloaded from the server-computers (114) or another location, but installed on the users individual computer. The web pages (112) are any of the pages available on the world wide web.

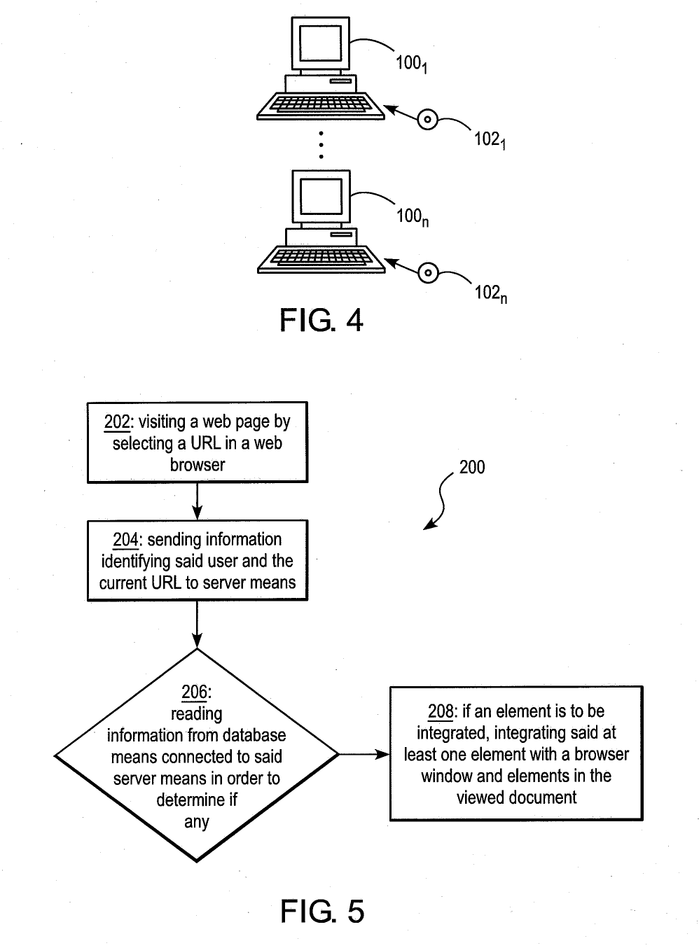

In FIG. 4, some computer software products 102₁, . . . , 102ₙ according to the present invention are schematically shown. In FIG. 4, n different digital computers 100₁, . . . , 101ₙ are shown, where n is an integer. In FIG. 4, n different computer software products 102₁, . . . , 102ₙ are shown, here shown in the form of CD discs. The different computer software products 102₁, . . . , 102ₙ are directly loadable in the internal memory of the n different digital computers 100₁, . . . , 100ₙ. Each computer software product 102₁, . . . , 102ₙ comprises software code portions for executing a part of or all the steps according to FIG. 3 when the product/products 102₁, . . . , 102ₙ are run on said computer 100₁, . . . , 100ₙ. The computer software products 102₁, . . . , 102ₙ may, for instance, be in the form of diskettes, RAM discs, magnetic tapes, magneto-optical discs or some other suitable products.

FIG. 5 is a graphical representation of a method for changing a web page with at least one element. The method (200) includes visiting a web page by selecting a URL in a web browser (202), sending information identifying said user and the current URL to server means (204), and reading information from database means connected to said server means in order to determine if any element is to be integrated for said user (206). If an element is to be integrated, said at least on element is then integrated with a browser window and elements in the viewed document (208).

Step by step description of usage and function:

Installation:
1. The user visits http://stix.to using a web browser, and signs up for an account by providing an email address and a desired username.
2. The user downloads a plug in for his or her web browser. The plugin is based on the open source program Greasemonkey, which makes it possible to run a javascript program in the web browser after a page is loaded.

A visit on a page without any marks:
3. The user visits a webpage of his or her choice.
4. The plug in automatically executes a program which makes a request to the stix.to server. The request is a question if any marks shall be shown.
5. The stix.to server determines if any notes, bookmarks or other marks shall be shown for the user on this page. This is determined by a computer program that reads data from a database
6. For this example, we presume that no marks shall be shown on this page.
7. In all cases, the plug in adds a little javascript program to the HTML code that is loaded in the web browser. This program enables creating new marks.

Create a Mark:
8. The user invokes the program in step 7 by clicking a button, making a choice in a menu or pressing a set of keys.
9. The javascript program from step 7 is executed, and it retrieves another program from the marks server.
10. The retrieved program is executed, and it adds a window in front of the current html page containing icons resembling marks to choose from.
11. The user clicks on one of the icons, in this example the notes icon. Either directly or through another retrieval from the server, another javascript program is executed which adds a post it style note, floating in front of the html page.
12. The user writes in the new note, changes its placement by dragging the window and so on.
13. When this happens, the javascript code on the client sends the new information about the text and coordinate, and similar state information to the marks server.
14. A program on the server saves the state information to the database.
15. When the user is finished, he or she leaves and visits another page.

Visit with a Mark:
16. Suppose that the user gets back to the same page later.
17. As before, step 4 and 5 is executed. in this case the previously created mark shall be shown.
18. A javascript program for post it style notes is created on the server, containing the state information previously saved to the database. The javascript program is returned to client.
19. The client executes the received code, and will add the previously made note at the same place on the website as it was left earlier.

On the Homepage:
20. If the user visits the website of the marks server, additional services are available. He or she can see a list of pagers with marks, read comments about his writings, upload and design graphics, connect with friends and similar services. Some are described earlier. Adapting the design and appearance of the marks without having to update the client program is possible because the client javascript code is generated on the marks server and sent to the client on demand. In the current implementation the client side javascript program is generated by another computer language (Common Lisp).

Another sample is a speaking mark. The current implementation of a speaker mark works like this. The user follows steps 1 to 11. By clicking a mouth icon instead of a note icon, a form with two fields and one button is shown. The user writes some words in one field, and the username of the receivers in the second form. When he or she clicks the Speak button, the words are sent to the marks server. The marks server invokes a speech synthesis system which generates a sound file (a wav file). This file is stored on the mark server, and its URL (the web address) is returned to the client. The client adds the following html element the message is then spoken out loud:

<embed src=“the returned url.wav” hidden=true autostart=true loop=false/>

The current implementation uses the Festival speech synthesizer from University of Edinburgh.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A system operable to change a web page with at least one element, the system comprising computer means connected to a distributed computer network, display means connected to said computer means and operable to display images, and speaker means connected to said computer means operable to reproduce sounds, which computer means is, wherein said computer means comprises a web browser operable to show web pages on said display means, wherein said web browser comprises modification means operable to integrate to said at least one element with a browser window and the elements in the viewed document.

2. A system operable to change a web page with at least one element according to claim 1, wherein said system also comprises server means connected to said modification means, and database means connected to said server means, wherein, after said web browser has downloaded an HTML document, said modification means is operable to send information identifying a user of the computer means and a current URL to said server means, which in turn is operable to read information in said database means in order to determine if any element is to be integrated for said user.

3. A system operable to change a web page with at least one element according to claim 2, wherein, if it is determined that an element is to be integrated, said server means is operable to generate said element as program code, which is returned to said modification means, which in turn is operable to execute said program code, which alters the HTML of said web page and creates a modified version for reproducing on said display means or said speaker means.

4. A system operable to change a web page with at least one element according to claim 1, wherein said element can be in the form of a note, a bookmark, a hotmark, a sticker, a spray can, an avatar, a spoken message or a sound effect.

5. A method for changing a web page with at least one element, which method comprises the steps:
visiting a web page by selecting a URL in a web browser;
sending information identifying said user and the current URL to server means;
reading information from database means connected to said server means in order to determine if any element is to be integrated for said user; and
if an element is to be integrated, integrating said at least on element with a browser window and elements in the viewed document.

6. At least one computer program product directly loadable into an internal memory of at least one digital computer, comprising software code portions for performing the steps of claim 5 when said at least one product runs on said at least one computer.
